(19) United States
(12) Patent Application Publication
(10) Pub. No.: US 2002/0150346 A1
(43) Pub. Date: Oct. 17, 2002

(54) Adapter

(76) Inventors: Masato Shiino, Tokyo (JP); Hideki Miyazaki, Tokyo (JP)

Correspondence Address: KNOBBE MARTENS OLSON & BEAR LLP, 2040 MAIN STREET, FOURTEENTH FLOOR, IRVINE, CA, 91614, US

(21) Appl. No.: 10/122,468

(22) Filed: Apr. 11, 2002

(30) Foreign Application Priority Data
Apr. 13, 2001 (JP) 2001-115928
Apr. 27, 2001 (JP) 2001-132144

(51) Int. Cl. G02B 6/36; G02B 6/38

(52) U.S. Cl. 385/53; 385/55

(57) ABSTRACT

An adapter having a plurality of receptacles in which optical connector plugs are housed, and connected to the optical connector plug housed in any of the receptacles. The adapter has a member made of a conductive material and disposed between the plurality of receptacles. The member has a opening in its central portion, and a grounding piece formed in a desired position.

### FIELD OF THE INVENTION

The present invention relates to an adapter.

### BACKGROUND OF THE INVENTION

Conventionally, in an optical module, for example, a semiconductor laser module, the intensity of electromagnetic waves radiated from the semiconductor laser module has been negligible because the optical power output from the semiconductor laser has been small.

However, with the advancement of optical communication technologies, recent optical modules are required to provide high power, so that large currents flow in electronic circuits contained therein, thereby causing an increasingly higher intensity of electromagnetic waves radiated to the outside. Thus, some optical modules may exert electromagnetic influences on electronic circuits disposed therearound.

In an optical module which is provided with a receptacle at an end for connection with an optical connector, a shielding measure is taken for removing such electromagnetic influences.

However, no adapters used in connecting optical connectors to each other have been provided with such shielding measures as mentioned above. Moreover, since the adapters are mounted on wiring boards and the like, there is a need for taking such shielding measures as mentioned above simply and inexpensively.

### SUMMARY OF THE INVENTION

It is an object of the present invention to provide an adapter which makes it possible to take shielding measures simply and inexpensively to remove electromagnetic influences.

To achieve the above object, an adapter of the present invention has a plurality of receptacles in which optical connector plugs are housed and is connected to the optical connector plug housed in any of the receptacles. The adapter comprises a member made of a conductive material and disposed between the plurality of receptacles. The member has an opening in its central portion, and a grounding piece formed in a desired position.

Also, to achieve the above object, an adapter of the present invention has a plurality of receptacles in which optical connector plugs are housed and is connected to the optical connector plug housed in any of the receptacles. The adapter comprises a housing made of a conductive material and attached to at least one of the plurality of receptacles.

The above and other objects, features and advantages of the present invention will be clearer from the following detailed description based on the accompanying drawings.

### BRIEF DESCRIPTION OF THE DRAWINGS

FIG. 1 is an exploded perspective view illustrating a first embodiment of an adapter according to the present invention;

FIG. 2 is an exploded perspective view illustrating an exemplary modification to the adapter of FIG. 1;

FIG. 3 is an exploded perspective view illustrating another exemplary modification to the adapter of FIG. 1;

FIG. 4 is a perspective view illustrating a second embodiment of the adapter according to the present invention, before a housing is attached to one receptacle of the adapter;

FIG. 5 is a perspective view illustrating the adapter of FIG. 4 with the housing attached to one receptacle of the adapter; and

FIG. 6 is a perspective view illustrating the adapter of FIG. 4 with housings attached to both receptacles of the adapter.

### DETAILED DESCRIPTION

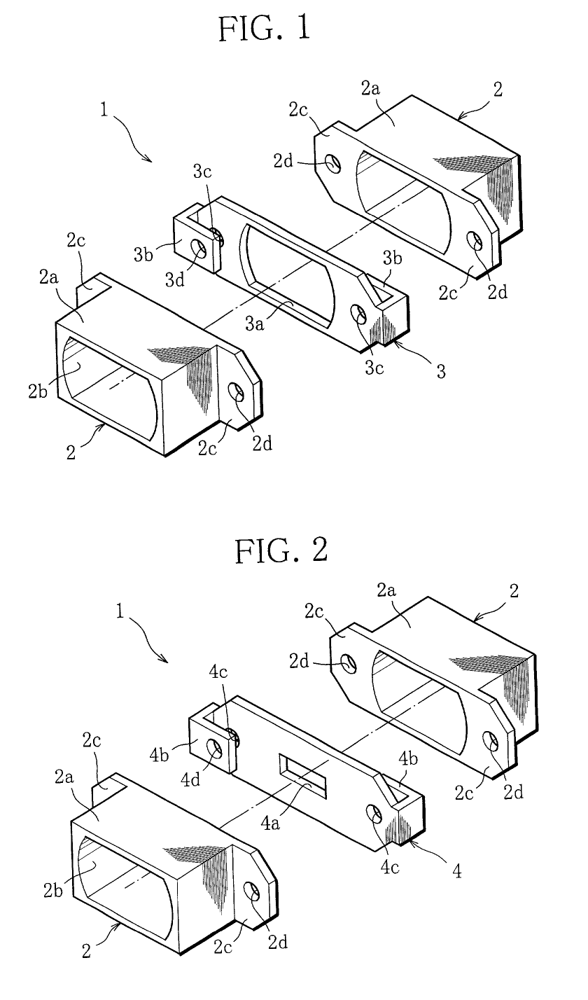

In the following, a first embodiment of an adapter according to the present invention will be described in detail with reference to FIGS. 1 through 3.

An adapter 1 comprises a conductive plate 3 between two receptacles 2. Here, optical connector plugs are housed in the receptacles 2 of the adapter 1 from both sides and connected with each other.

Each of the receptacles 2 is molded of a synthetic resin such as polybutyleneterephthalate (PBT), polyphenylenesulphide (PPS) or the like, and comprises a prismatic body 2a; an opening 2b formed in a front portion of the body 2a for receiving a plug or a multifiber connector, for example, an MPO (Multifiber Push-On) connector or the like which is inserted through the opening 2b; and flanges 2c formed in a rear portion of the body 2b and extending on both sides of the body 2b. Each of the flanges 2c is formed with a screw hole 2d for fixation to a panel of a wiring board, not shown. Here, the panel of the wiring board is made of a conductive metal, and is grounded beforehand.

The conductive plate 3 is molded in plate shape using a conductive resin which comprises, for example, carbon powder, or conductive metal powder such as copper, aluminum, silver or the like uniformly mixed in a synthetic resin such as polybutyleneterephthalate (PBT), polyphenylenesulphide (PPS) or the like, or a conductive metal such as copper, aluminum, silver or the like. The conductive plate 3 is formed with an opening 3a in its central portion, and is provided with grounding pieces 3b on both sides, one of which protrudes to the front and the other to the rear of the conductive plate 3. The conductive plate 3 is formed with screw holes 3c through which screws are inserted on both sides of the opening 3a. The opening 3a is formed slightly larger than a cover which covers a ferrule of the MPO connector. Each of the grounding pieces 3b is formed with a screw hole 3d in a position corresponding to the screw hole 3c for fixation to a panel of a wiring board, not shown.

The adapter 1 is constructed as described above, and is integrated by inserting each of the flanges 2c into each grounding piece 3b, positioning the two receptacles 2 on both surfaces of the conductive plate 3, matching the corresponding screw holes 2d and 3d, depositing portions of the receptacles 2, or bonding them using an adhesive or the like. Then, the adapter 1 is disposed in an opening (not shown) formed in the panel for mounting the adapter 1, and the adapter 1 is fixed to the panel by screws inserted through the screw holes 2d, 3c, 3d. In this manner, the conductive plate 3 of the adapter 1 is grounded through the panel.

With the foregoing structure, even if the adapter 1 is connected to a multifiber connector which is connected to a high power optical module, the conductive plate 3 allows strong electromagnetic waves to escape to the ground through the panel, thereby making it possible to remove the electromagnetic influences simply and inexpensively.

In the adapter 1 described above, a conductive plate 4 illustrated in FIG. 2 may be used in place of the conductive plate 3. Specifically, the conductive plate 4 is formed, in place of the opening 3a, with an opening 4a, in its central portion, which is slightly larger than the profile of the ferrule of the MPO connector and smaller than the opening 3a, and is provided with grounding pieces 4b on both sides, one of which protrudes to the front side and the other to the rear of the conductive plate. The conductive plate 4 is formed with screw holes 4c on both sides of the opening 4a, through which screws are inserted. Each of the grounding pieces 4b is formed with a screw hole 4d at a position corresponding to the screw hole 4c for fixation to a panel of a wiring board, not shown.

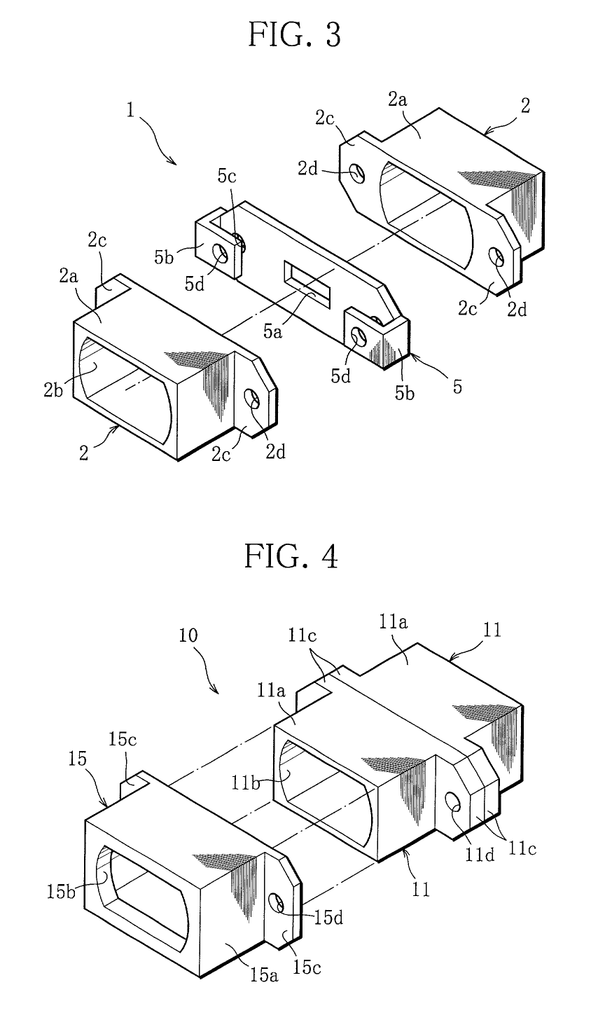

Alternatively, as a conductive plate 5 illustrated in FIG. 3, the adapter 1 may be provided with grounding pieces 5b on both sides of an opening 5a, both of which protrude on one side of the conductive plate 5. In this event, as is the case with the conductive plates 3, 4, the conductive plate 5 is formed with screw holes 5c on both sides of the opening 5a, through which screws are inserted. Each of the grounding pieces 5b is formed with a screw hole 5d at a position corresponding to the screw hole 5c.

Further alternatively, the adapter 1 may be fabricated by setting the conductive plate 3, 4, 5, when the conductive plate 3, 4, 5 is a metal, in a mold, and integrally molding the receptacles 2 on both sides of the conductive plate 3, 4, 5 by insert molding or the like.

In the adapter 1, means for fixing the adapter 1 to the panel is not limited to screws, as long as the conductive plate 3, 4, 5 can be grounded through the panel.

Next, a second embodiment of the adapter according to the present invention will be described in detail with reference to FIGS. 4 through 6.

As illustrated in FIG. 4, the adapter 10 is integrally formed by depositing two receptacles 11 or bonding them with an adhesive or the like. A housing 15 is attached to at least one of the receptacles 11. In this event, optical connector plugs are inserted into the receptacles 11 of the adapter 10 from both sides thereof and connected with each other.

The receptacle 11 comprises a prismatic body 11a; an opening 11b formed in a front portion of the body 11a for receiving a multifiber connector, for example, an MPO (Multifiber Push-On) connector or the like which is inserted through the receptacle 11; and flanges 11c formed in a rear portion of the body 11b and extending on both sides of the body 11b. Each of the flanges 11c is formed with a screw hole 11d for fixation to a panel of a wiring board, not shown. Here, the panel of the wiring board is made of a conductive metal, and is grounded beforehand.

The housing 15 is molded substantially in the same shape as the receptacle 11 using the same conductive material as the conductive plate 3, and covers the receptacle 11. The housing 15 comprises a prismatic body 15a; an opening 15b formed in a front portion of the body 15a; and flanges 15c extending on both sides in a rear portion of the body 15a and formed with screw holes 15d. The opening 15b is sized such that a multifiber connector can be inserted therethrough. The opening 15b, when excessively large, causes a reduced shielding effect for electromagnetic waves, and when excessively small, prevents a multifiber connector from being inserted therethrough.

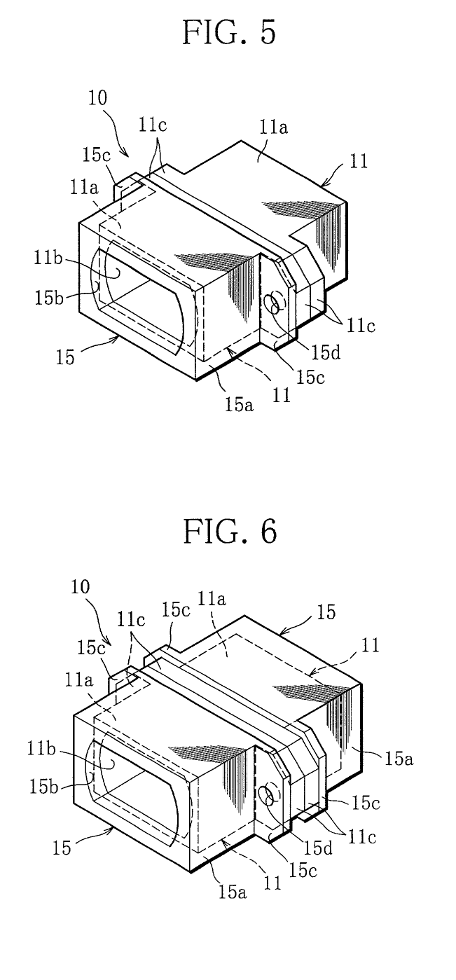

The adapter 10 is constructed as described above, and for example, when the two receptacles 11 have been previously fixed on a panel of a wiring board, the housing 15 is retrofitted to one receptacle 11, as illustrated in FIG. 5. This causes the adapter 10 to sandwich the panel of the wiring board between the flange 11c of the one receptacle 11 and the flange 15c, so that the housing 15 is grounded through the panel.

Thus, even if the adapter 10 is connected to a multifiber connector connected to a high power optical module, the housing 15 shields strong electromagnetic waves. In this manner, the adapter 10 can remove electromagnetic influences simply and inexpensively.

Alternatively, when the adapter 10 is newly mounted to the panel of the wiring board, the adapter 10 may be fixed to the panel by fitting the housing 15 on one receptacle 11, inserting the other receptacle 11 into an opening (not shown) formed in the panel for mounting, and inserting screws through the screw holes 11d, 15d of the flanges 11c, 15c from the screw holes 15d of the housing 15.

Here, in the adapter 10, means for fixing the adapter 10 to the panel is not limited to screws, as long as the housing 15 can be grounded through the panel.

As illustrated in FIG. 6, when the housings 15 are attached to both receptacles 11, the adapter 10 provides a further improved shielding effect for electromagnetic waves.

While the foregoing embodiments have been described for an adapter for a multifiber connector which is an MPO connector, it should be understood that a multifiber connector connected to the adapter is not limited to the MPO connector. Also, the adapter of the present invention can be applied to an adapter for a single-fiber connector.

Additionally, the adapter 10 may be manufactured by previously molding the two receptacles 11 integrally beforehand, other than integrally forming the two receptacles 11 by depositing them, or bonding them with an adhesive or the like, as in the foregoing embodiments.

What is claimed is:

1. An adapter having a plurality of receptacles in which optical connector plugs are housed, said adapter being connected to said optical connector plug housed in any of said receptacles, said adapter comprising:
a member made of a conductive material and disposed between said plurality of receptacles, said member having an opening in its central portion, and a grounding piece formed in a desired position.

2. An adapter having a plurality of receptacles in which optical connector plugs are housed, said adapter being connected to said optical connector plug housed in any of said receptacles, said adapter comprising:
a housing made of a conductive material and attached to at least one of said plurality of receptacles.
